(19) United States
(12) Patent Application Publication
(10) Pub. No.: US 2026/0051334 A1
(43) Pub. Date: Feb. 19, 2026

(54) DISK DRIVE SUSPENSION

(71) Applicant: NHK SPRING CO., LTD., Yokohama-shi (JP)

(72) Inventors: Masao HANYA, Yokohama-shi (JP); Toshiki ANDO, Yokohama-shi (JP)

(73) Assignee: NHK SPRING CO., LTD., Yokohama-shi (JP)

(21) Appl. No.: 19/296,587

(22) Filed: Aug. 11, 2025

(30) Foreign Application Priority Data
Aug. 14, 2024 (JP) 2024-135301

(51) Int. Cl. G11B 5/48

(52) U.S. Cl. CPC G11B 5/4833

(57) ABSTRACT

According to one embodiment, a suspension includes a load beam having a dimple portion and a flexure including a slider-mounted portion. A convex surface of the dimple portion is in contact with the slider-mounted portion. A radius of curvature of the convex surface is less than 0.10 mm, and a gain defined in the following equation is 0.9 or more. In the following equation, a is an input amplitude, A is amplitude, R is a radius of curvature of the convex surface, and Fpr is a flexure pitching resistance. k1 is a pitching stiffness of air bearing, and k2 is a pitching stiffness of the slider-mounted portion.

$$Gain = \frac{A - \frac{{RF}_{pr}}{{k}_{1} + {k}_{2}}}{a}$$

### CROSS-REFERENCE TO RELATED APPLICATIONS

This application is based upon and claims the benefit of priority from prior Japanese Patent Application No. 2024-135301, filed Aug. 14, 2024, the entire contents of which are incorporated herein by reference.

### BACKGROUND OF THE INVENTION

### 1. Field of the Invention

The present invention relates to a disk drive suspension including a swingable slider-mounted portion on which a slider is mounted.

### 2. Description of the Related Art

A hard disk drive (HDD) is used in an information processing apparatus such as a personal computer. The hard disk drive includes a magnetic disk rotating about a spindle, a carriage turning about a pivot, and the like. The carriage includes an arm and swivels about the pivot by a positioning motor such as a voice coil motor.

A disk drive suspension (hereinafter simply referred to as a suspension) is mounted on the arm of the carriage. The suspension includes a load beam, a flexure provided along the load beam, and the like. A slider is mounted on a slider-mounted portion formed near a distal end of the flexure. In this industry, the slider-mounted portion is often referred to as a tongue. The slider moves integrally with the slider-mounted portion, in at least a pitching direction. Therefore, as mentioned herein, a pitch angle of the slider-mounted portion may also be referred to as a slider pitch angle.

A gimbal assembly is configured by the load beam, the flexure, the slider, and the like. The slider is provided with elements for performing access such as reading or writing data. When a disk drive is used, data access to the recording surface of the disk is performed by the elements of the slider while the disk is rotating.

Examples of suspensions are disclosed in JP 2014-22013 A (Patent Literature 1) and JP 2020-140749 A (Patent Literature 2). Each of these suspensions has a slider-mounted portion. A convex surface of a dimple portion is in contact with the slider-mounted portion. The dimple portion is provided on the load beam. The slider-mounted portion is elastically supported by a gimbal component such as outriggers and swings around the convex surface of the dimple portion. The slider is fixed to the slider-mounted portion by adhesion or the like. The slider-mounted portion mentioned herein is not only a portion where the slider is adhered but also a portion including its surrounding. In other words, the slider-mounted portion indicates an entire swingable area which is elastically supported by the gimbal component.

When the disk rotates, air flows between a leading side end of the slider and a trailing side end of the slider, forming an air bearing. The “leading side” mentioned herein refers to the side where air flows into a space between the slider and the disk when the disk rotates. The “trailing side” refers to the air outflow side.

To accommodate the increase in recording density of the disk, the distance between the slider and the disk tends to decrease. When the disk rotates and the air bearing is formed, an example of the distance between the leading side end of the slider and the disk is 100 nm. In contrast, an example of the distance between the trailing side end of the slider and the disk is 10 nm.

Although the recording surface of the disk seems flat, waviness with amplitudes of several micrometers may actually occur in the circumferential direction of the disk. The prevent inventors examined the flatness of the disk. As a result, a tendency was found in which the waviness in the outer circumferential area of the disk was larger as compared to those in the vicinity of the center clamp portion near the center of rotation of the disk. The slider needs to move in the pitching direction to follow the waviness on the disk.

The slider oscillates around the convex surface of the dimple portion relative to the load beam. As described herein, a behavior of the leading side portion of the slider moving away from or toward the load beam in the longitudinal direction of the suspension is referred to as pitching. The pitch angle is the angle in the pitching direction from a reference position. As described herein, the movement of the leading side portion of the slider toward the load beam is referred to as moving in a positive pitch angle direction. In addition, the movement of the leading side portion of the slider away from the load beam is referred to as moving in a negative pitch angle direction.

When the slider moves over mountains of waviness on the disk toward the peaks, the slider moves in the negative pitch angle direction along the disk surface. When the slider moves toward the bottom of the waviness, the slider moves in the positive pitch angle direction along the disk surface.

The slider is tilted at a slight positive pitch angle relative to the disk surface. This pitch angle is generally very small, for example, 0.006°. When an amplitude of the waviness is, for example, 3 to 6 μm, the slider needs to change at a relatively large angle, for example, +0.03 to +0.06° in the pitching direction.

Recently, the length of the suspension tends to be shorter with the evolution of disk drives. The load beam is provided at a certain angle relative to the disk surface in the pitching direction. The slider-mounted portion provided at the tip of the load beam moves in the pitching direction around the dimple portion relative to the load beam. As the length of the suspension decreases, the change in angle of the slider in the pitching direction becomes larger. It is known that, for example, when the length of the suspension becomes approximately 6 mm, the change in angle of the slider becomes larger.

If the slider cannot quickly follow the waviness on the disk, the slider may excessively approach the disk surface. Then, high-temperature areas may be formed due to friction occurring at the slider, the disk, or the air bearing. In extreme cases, the slider may come into contact with the disk, and the disk or the slider may be damaged.

The present inventors found, through intensive research, cases in which the slider excessively approaches the disk in areas where the pitch angle changes significantly, such as areas in the vicinity of the mountain peaks of the waviness on the disk or in the vicinity of bottoms of the waviness. Then, the present inventors obtained knowledge that the gain value relative to the input amplitude is important to avoid the interference between the disk and the slider. The details of the gain will be described later.

In this industry, it has been conventional to consider that the slider-mounted portion such as the tongue swings in a state of being substantially in contact with the convex surface of the dimple portion at a single point. Since the contact between the convex surface of the dimple portion and the slider-mounted portion is equivalent to the contact between a spherical surface rolling on a plane and the plane, the contact has been considered as Hertzian elastic contact. In Hertzian elastic contact, friction between the slider-mounted portion (plane) and the convex surface of the dimple portion (spherical surface) can be effectively ignored. For this reason, it was not considered that the movement of the slider-mounted portion was influenced by friction with the convex surface.

An embodiment described herein relates generally to providing a disk drive suspension capable of suppressing interference between a rotating disk and a slider.

### BRIEF SUMMARY OF THE INVENTION

As a result of intensive research, the present inventors found that a force similar to the friction in the opposite direction of the pitching direction was generated at the contact part between the convex surface of the dimple portion and the slider-mounted portion. The present inventors referred to this force as flexure pitching resistance (Fpr). Fpr is an abbreviation of Flexure Pitching Resistance. The flexure pitching resistance (Fpr) occurs at the contact part between the slider-mounted portion and the convex surface when the slider-mounted portion swings on the convex surface of the dimple portion.

A suspension according to one embodiment comprises a load beam including a dimple portion, and a flexure provided along the load beam. The flexure includes a slider-mounted portion on which the slider is mounted. The slider-mounted portion has a first surface facing the load beam and a second surface to which the slider is fixed by adhesion or the like. The convex surface of the dimple portion is in contact with the first surface of the slider-mounted portion at a contact part. The slider-mounted portion is supported by a gimbal component so as to be swingable at least in the pitching direction. The suspension of the present embodiment was effective in avoiding interference between the disk and the slider by setting the gain to 0.9 or more. The definition of the gain will be described in detail later.

When the gain was 0.95 or more, the suspension was further effective in avoiding interference between the disk and the slider. It was also found that the radius of curvature of the convex surface and the flexure pitching resistance (Fpr) affect the gain. The radius of curvature of the convex surface in the present embodiment is less than 0.10 mm, and 0.04 mm or more. More desirably, the radius of curvature of the convex surface is less than 0.85 mm. The flexure pitching resistance (Fpr) is 0.005 N or less.

According to a suspension of one embodiment of the present invention, interference between a slider which moves in the pitching direction in response to waviness of a rotating disk and the disk can be suppressed.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a plan view showing a part of a suspension according to one embodiment.

FIG. 2 is a cross-sectional view showing a part of the suspension and the slider along F2-F2 line in FIG. 1.

FIG. 3 is a schematic cross-sectional view showing an example of a disk drive.

FIG. 4 is a schematic side view showing a part of the suspension, the slider, and a part of the disk shown in FIG. 2.

FIG. 5 is a schematic side view showing a state in which the slider shown in FIG. 4 has moved in a negative pitch angle direction.

FIG. 6 is a schematic side view showing a state in which the slider shown in FIG. 4 has moved in a positive pitch angle direction.

FIG. 7 is a schematic diagram showing a motion system of the suspension, the slider, and the disk shown in FIG. 4.

FIG. 8 is a graph showing a relationship between a slider pitch angle obtained by calculation, and the disk rotation angle.

FIG. 9 is a graph showing a relationship between an actual slider pitch angle, and the disk rotation angle.

FIG. 10 is a schematic diagram showing a relationship between a profile of the disk and the pitch angle of the slider.

FIG. 11 is a graph showing a relationship between the pitch angle of the disk and the pitch angle of the slider in an example in which a gain is 0.701.

FIG. 12 is a graph showing the relationship between the pitch angle of the disk and the pitch angle of the slider in an example in which a gain is 0.934.

FIG. 13 is a graph showing a relationship between the pitch angle of the disk and the pitch angle of the slider in an example in which a gain is 0.105.

FIG. 14 is a diagram showing gains for respective samples Nos. 1 to 17.

FIG. 15 is a graph showing a relationship between flexure pitching resistance Fpr and the gain.

FIG. 16 is a graph showing a relationship between a radius of curvature R of a convex surface and the gain.

### DETAILED DESCRIPTION OF THE INVENTION

A disk drive suspension according to one embodiment will be described hereinafter with reference to the accompanying drawings. The disk drive suspension may be hereinafter simply referred to as a suspension.

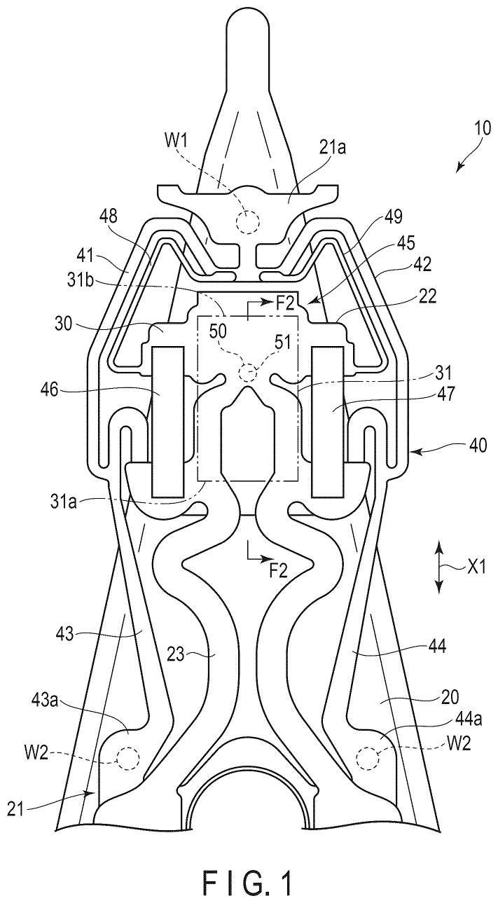

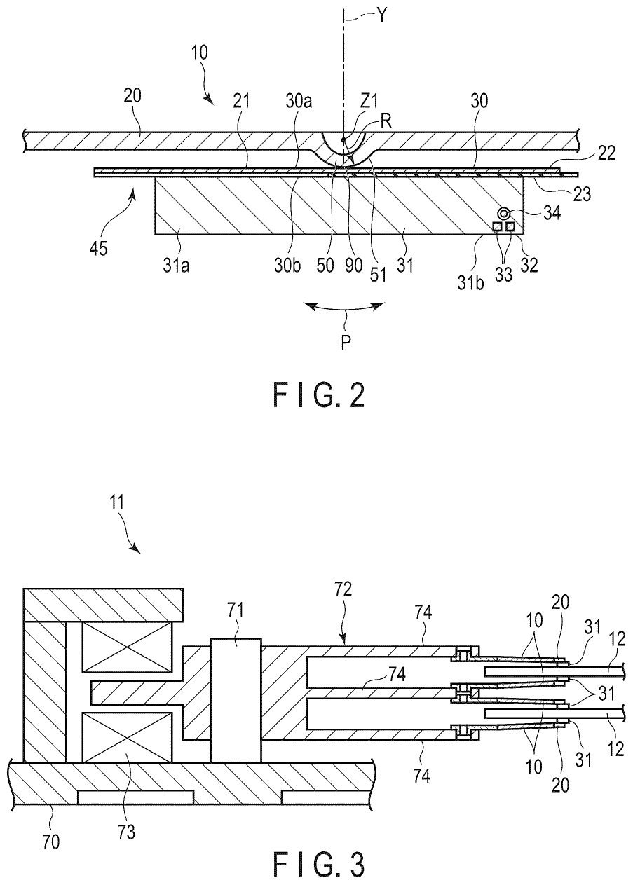

FIG. 1 is a plan view showing a part of the suspension 10. FIG. 2 is a cross-sectional view showing the part of the suspension 10 along F2-F2 line in FIG. 1. FIG. 3 is a schematic cross-sectional view showing an example of a disk drive 11 including the suspension 10. The disk drive 11 has one or more disks 12. The disk drive 11 will be described later and, first, the suspension 10 will be described.

The suspension 10 includes a load beam 20, and a flexure 21 provided along the load beam 20. The load beam 20 is formed of a stainless steel plate and extends in a length direction of the suspension 10. The direction indicated by double-headed arrow X1 in FIG. 1 is a longitudinal direction of the load beam 20, i.e., the longitudinal direction of the suspension 10. A thickness of the load beam 20 is, for example, 20 to 40 μm, but may be the other thickness.

The flexure 21 includes a metal base 22 formed of a thin stainless steel plate and a wiring portion 23 provided along the metal base 22. An example of the thickness of the metal base 22 is 20 μm (12 to 25 μm). The thickness of the metal base 22 is smaller than the thickness of the load beam 20.

As shown in FIG. 1, the metal base 22 is fixed to the load beam 20 by a plurality of weld portions (for example, first weld portion W1 and second weld portion W2). The wiring portion 23 includes a base insulating layer formed of an electrically insulating resin such as polyimide, a plurality of conductors formed on the base insulating layer, and a cover layer covering the conductors.

A slider-mounted portion 30 is formed at a part of the metal base 22. In this industry, the slider-mounted portion 30 may be referred to as a tongue. The “slider-mounted portion” as described herein means one of portions of the flexure, and a portion on which the slider is to be mounted. In other words, the “slider-mounted portion” may also refer to a “mounting portion for slider” or a “portion on which the slider is to be mounted”. As shown in FIG. 2, the slider-mounted portion 30 has a first surface 30a and a second surface 30b. The first surface 30a faces the load beam 20. The second surface 30b is on the side opposite to the first surface 30a in the thickness direction of the metal base 22. A slider 31 is fixed to the second surface 30b by fixing means such as an adhesive.

The slider 31 is provided on the second surface 30b of the slider-mounted portion 30 with the wiring portion 23 interposed therebetween. A part of the slider 31 is fixed to the slider-mounted portion 30 by an adhesive. The slider 31 has a leading side portion 31a and a trailing side portion 31b with respect to the rotational direction of the disk 12. As described herein, the “leading side” refers to an inflow side of air flowing between the disk 12 and the slider 31 in a state in which the disk rotates. The “trailing side” refers to the air outflow side.

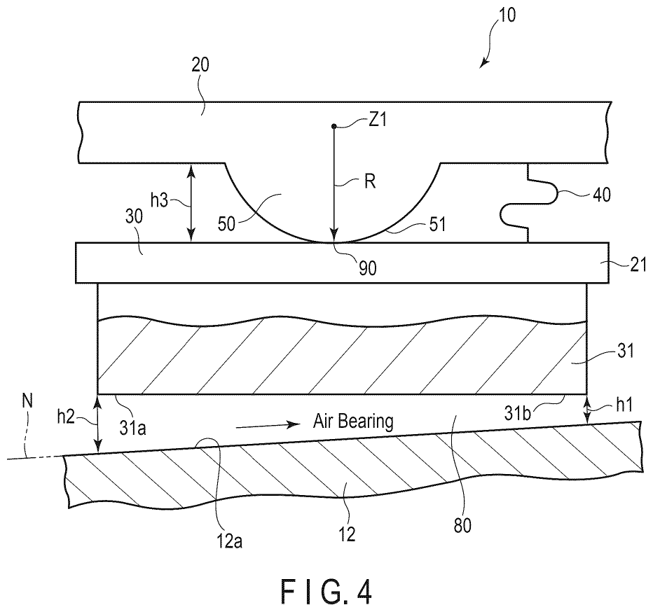

A plurality of elements 33 capable of performing conversion between magnetic signals and electrical signals are provided at a trailing side end 32 of the slider 31. An example of the elements 33 is an MR element. These elements 33 are used to make access such as writing or reading data to or from the recording surface of the disk 12. A heater 34 may be provided in the vicinity of the elements 33. When electric current is applied to the heater 34, the trailing side portion 31b is heated and expands. A distance h1 (shown in FIG. 4 to FIG. 6) between the trailing side portion 31b and the disk 12 can be thereby further reduced. For example, the distance h1 can be reduced to 1 nm or less.

The distance h1 between the trailing side portion 31b of the slider 31 and the disk 12 may be referred to as head media spacing (HMS). The distance h1 is shorter than a distance h2 between the leading side portion 31a and the disk 12. While h2 is, for example, 100 nm, h1 is, for example, 10 nm.

As shown in FIG. 1, the slider-mounted portion 30 is elastically supported on the load beam 20 by the gimbal component 40. An example of the gimbal component 40 includes first arms 41 and 42 and second arms 43 and 44. The first arms 41 and 42 and the second arms 43 and 44 are formed of parts of the metal base 22. The gimbal component 40 may vary depending on the design of the flexure 21 and is not limited to the example shown in FIG. 1.

A gimbal portion 45 is formed in a portion of the flexure 21 by the slider-mounted portion 30, the gimbal component 40, and the like. The slider-mounted portion 30 is a swingable portion elastically supported by the gimbal component 40. The slider-mounted portion includes a part where the slider 31 is adhered and its surrounding. Actuator elements 46 and 47 may be provided on both sides of the slider 31. The actuator elements 46 and 47 are formed of, for example, piezoelectric bodies of lead zirconate titanate (PZT). By applying a voltage to the actuator elements 46 and 47, the trailing side portion 31b of the slider 31 can be rotated slightly in the width direction.

The distal end sides of the first arms 41 and 42 are each supported on the load beam 20 by the first welded portion W1. The proximal portions 43a and 44a of the second arms 43 and 44 are each fixed to the load beam 20 by the second welded portion W2. The slider-mounted portion 30 is elastically supported so as to be swingable relative to the load beam 20 by the gimbal component 40.

Limiter members 48 and 49 may be provided between the slider-mounted portion 30 and a distal end portion 21a of the flexure 21. The limiter members 48 and 49 are formed of a resin such as polyimide. The limiter members 48 and 49 suppress excessive oscillation of the slider-mounted portion 30 when an external impact is applied to the suspension 10. The limiter members 48 and 49 may function as parts of the gimbal component 40, depending on the design of the flexure 21.

A dimple portion 50 is formed on the load beam 20. As shown in FIG. 2, the dimple portion 50 has a convex surface 51 that protrudes in a dome shape toward the slider-mounted portion 30. The convex surface 51 has a shape obtained by rotating an arc with a radius of curvature R around a vertical axis Y. Therefore, the convex surface 51 has an approximately circular shape in plan view of the slider-mounted portion 30. The arc with the radius of curvature R is not necessarily a perfect circle. In other words, the convex surface 51 has a shape similar to a part of a hemispherical surface. The vicinity of the tip of the convex surface 51 is in contact with the first surface 30a of the slider-mounted portion 30. The radius of curvature R is the radius of curvature at the point with which the first surface 30a may come into contact when the slider-mounted portion 30 swings. The other parts, i.e., parts which may not in contact with the first surface 30a, may have a radius of curvature other than the radius of curvature R.

As shown in FIG. 2, the convex surface 51 of the dimple portion 50 is in contact with the slider-mounted portion 30. In this state, the slider-mounted portion 30 swings at least in the pitching direction (indicated by double-headed arrow P in FIG. 2). As a result, the slider-mounted portion 30 generates at least vertical displacement centered on the convex surface 51. The slider-mounted portion 30 is supported by the gimbal component 40 so as to be swingable in at least the pitching direction (vertical swing direction) and the rolling direction (lateral swing direction) relative to the load beam 20. The gimbal component 40 may include outrigger members, arms, and the like.

FIG. 3 is a schematic cross-sectional view showing an example of a disk drive (HDD) 11. The disk drive 11 includes disks 12, a casing 70 (shown in part), a carriage 72, a positioning motor 73 for driving the carriage 72, and the like. The disks 12 rotate about spindles. The carriage 72 is pivotable about a pivot 71. The casing 70 is sealed by a lid. A suspension 10 is mounted at the tip of the arm portion 74 of the carriage 72.

When the carriage 72 is turned by the positioning motor 73, the suspension 10 moves in the radial direction of the disk 12. The sliders 31 thereby move to desired positions of the disks 12. When the disks 12 rotate, air flows from leading side portions 31a of the sliders 31 toward the trailing side portions 31b. Air bearing 80 is thereby formed between the disk 12 and the slider 31.

FIG. 4 schematically shows a surface 12a of the disk 12 along a flat reference plane N, the slider 31, and the dimple portion 50. The reference plane N is a virtual flat surface extending in a direction perpendicular to the central axis of the rotating disk 12. The slider-mounted portion 30 in a state of being elastically supported by the gimbal component 40 is in contact with the convex surface 51. Therefore, the slider-mounted portion 30 and the convex surface 51 are in contact with each other at a contact portion 90.

The slider-mounted portion 30 moves around center of curvature Z1 so as to roll over the convex surface 51, in a state of being in contact with the convex surface 51 at the contact portion 90. At this time, the convex surface 51 and the slider-mounted portion 30 are substantially in elastic contact (Hertzian elastic contact) between a plane and a sphere surface. Therefore, it has been considered that there is no slippage at the contact portion and that losses caused by friction are essentially negligible.

In fact, however, it was found that a force similar to friction acts on the contact portion 90 between the slider-mounted portion 30 and the convex surface 51. This force is the flexure pitching resistance Fpr discovered by the present inventors. The flexure pitching resistance Fpr can be obtained by analysis depending on the design of the flexure 21 (primarily, the design of the gimbal portion 45).

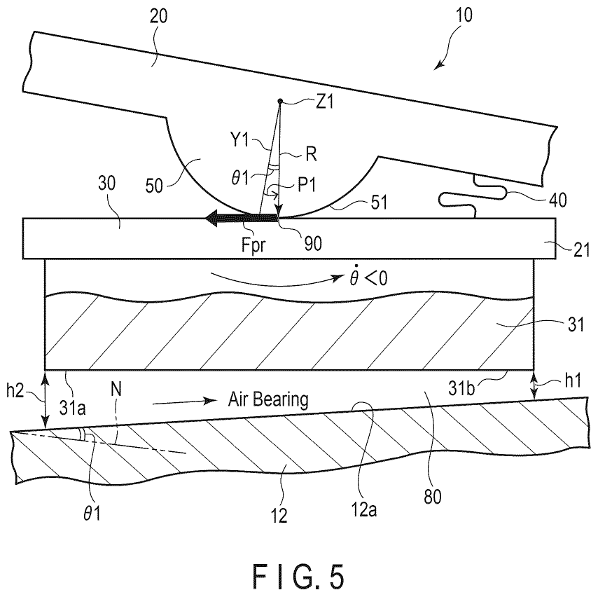

FIG. 5 schematically shows the slider 31 moving along the surface 12a with a negative pitch angle θ1 relative to the reference plane N. As shown in FIG. 5, when the slider 31 moves along the surface 12a with a negative pitch angle θ1, the contact portion 90 moves in a first direction P1 from a reference line Y1. The slider-mounted portion 30 rotates on the surface of the convex surface 51 without substantial slippage. At this time, the flexure pitching resistance Fpr in the direction opposite to the direction of movement of the slider-mounted portion 30 acts on the contact portion 90 in a tangential direction of the convex surface 51. The slider 31 is provided on the slider-mounted portion 30. Therefore, as described herein, the pitch angle of the slider 31 and the pitch angle of the slider-mounted portion 30 are synonymous with each other.

The flexure pitching resistance Fpr acts on the contact portion 90 as a moment of the radius of curvature R. Therefore, the torque around the center of curvature Z1 as expressed as a product of the flexure pitching resistance Fpr and the radius of curvature R (Fpr×R), acts on the slider-mounted portion 30. This torque increases as the radius of curvature R increases, supplying resistance to the slider-mounted portion 30 moving in the pitching direction.

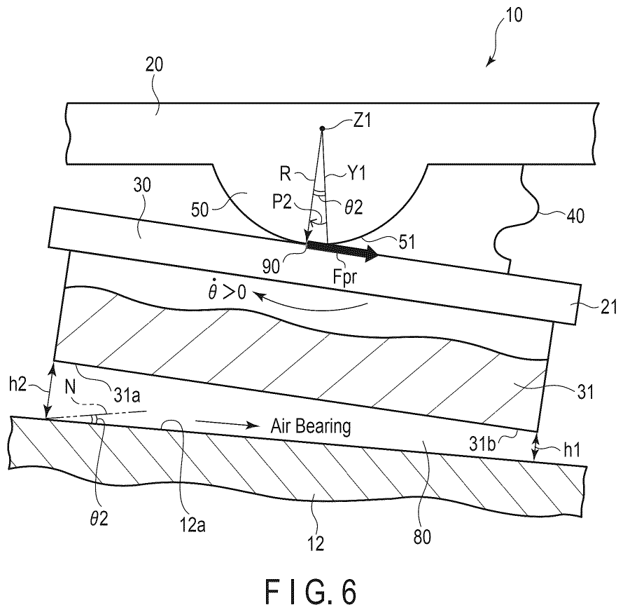

FIG. 6 schematically shows the slider 31 moving along the surface 12a with a positive pitch angle θ2 relative to the reference plane N. As shown in FIG. 6, when the slider 31 moves along the surface 12a with a positive pitch angle θ2, the contact portion 90 moves in a second direction P2 from the reference line Y1. The slider-mounted portion 30 rotates on the convex surface 51 without substantial slippage. At this time, the flexure pitching resistance Fpr in the direction opposite to the direction of movement of the slider-mounted portion 30 acts on the contact portion 90 in a tangential direction of the convex surface 51.

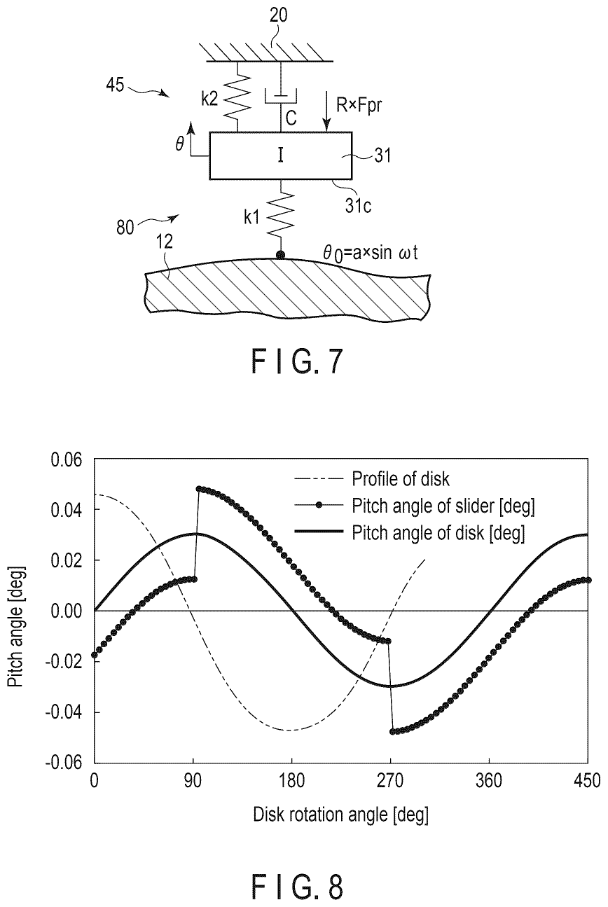

FIG. 7 is a schematic diagram showing the motion system including the slider 31. In equations shown below and in FIG. 7, k1 is the pitch stiffness ([Nm/rad]) of a slider surface 31c facing the air bearing 80. k2 is the pitch stiffness (pitch stiffness [Nm/rad]) of the gimbal portion 45 of the flexible 21. c is the viscous damping coefficient between the slider surface 31c facing the air bearing 80 and the gimbal portion 45. ζ is the viscous damping ratio. 0 is the pitch angle of the slider [rad], a is the input amplitude [rad], Fpr is the flexure pitching resistance [N], R is the radius of curvature of the convex surface of the dimple R [m] and, ω is the angular frequency [rad/s]. I is the inertia (mass) of the slider 31 including the slider-mounted portion 30 but, to simplify the calculation, only the inertia of the slider 31 is considered.

Fpr×R is the resistance torque, which acts in the opposite direction to the rotation direction. Therefore, the equations of motion for one degree of freedom are the following equations (1) and (2).
When \dot{θ}>0

$$I \ddot{θ} = - {k}_{1} ( θ - a sin ω t ) - c \dot{θ} - {k}_{2} θ - {RF}_{pr} \qquad ( 1 )$$

When \dot{θ}<0

$$I \ddot{θ} = - {k}_{1} ( θ - a sin ω t ) - c \dot{θ} - {k}_{2} θ - {RF}_{pr} \qquad ( 2 )$$

k₁; Pitch stiffness of ABS, k₂; Pitch stiffness of Fx,
c; Viscous damping coefficient of Fx,
R; Radius of dimple, Fpr; Flexure pitching resistance,
θ; Slider pitching angle,
a; Input amplitude, I; Slider inertia,
ω; Angular frequency.

By transforming the equations (1) and (2), the following equations (3) and (4) are obtained.
When \dot{θ}>0

$$\ddot{θ} + 2 ζ {ω}_{0} \dot{θ} + {ω}_{0}^{2} θ = \frac{{ak}_{1}}{I} sin ω t - \frac{{RF}_{p r}}{I} \qquad ( 3 )$$

When \dot{θ}<0

$$\ddot{θ} + 2 ζ {ω}_{0} \dot{θ} + {ω}_{0}^{2} θ = \frac{{ak}_{1}}{I} sin ω t + \frac{{RF}_{p r}}{I} \qquad ( 4 )$$

Here,

$${ω}_{0} = \sqrt{\frac{{k}_{1} + {k}_{2}}{I}}$$

is the circular natural frequency, and

$$ζ = \frac{c}{2 \sqrt{I ( {k}_{1} + {k}_{2} )}}$$

is the viscous damping ratio.

In equations (3) and (4), the principle of linear superposition is established. Therefore, the steady-state vibration solution is assumed to be the following equation (5).

$${θ}_{p} = U sin ω t + V cos ω t + C \qquad ( 5 )$$

If θp. \dot{θ}p, \ddot{θ}p are substituted into equations (3) and (4),
When θ>0

$$\{ ( {ω}_{0}^{2} - {ω}^{2} ) U - 2 {ζω}_{0} ω V \} sin ω t + \{ 2 ζ {ω}_{0} ω U + ( {ω}_{0}^{2} - {ω}^{2} ) V \} cos ω t + {ω}_{0}^{2} C = \frac{{ak}_{1}}{I} sin ω t - \frac{{RF}_{pr}}{I}$$

When \dot{θ}<0

$$\{ ( {ω}_{0}^{2} - {ω}^{2} ) U - 2 {ζω}_{0} ω V \} sin ω t + \{ 2 ζ {ω}_{0} ω U + ( {ω}_{0}^{2} - {ω}^{2} ) V \} cos ω t + {ω}_{0}^{2} C = \frac{{ak}_{1}}{I} sin ω t - \frac{{RF}_{pr}}{I}$$

When the left and right sides are compared,
When è>0

$$( {ω}_{0}^{2} - {ω}^{2} ) U - 2 {ζω}_{0} ω V = \frac{{ak}_{1}}{I}$$

$$2 {ζω}_{0} ω U + ( {ω}_{0}^{2} - {ω}^{2} ) V = 0$$

$${ω}_{0}^{2} C = - \frac{{RF}_{pr}}{I}$$

When \dot{θ}<0

$$( {ω}_{0}^{2} - {ω}^{2} ) U - 2 {ζω}_{0} ω V = \frac{{ak}_{1}}{I}$$

$$2 {ζω}_{0} ω U + ( {ω}_{0}^{2} - {ω}^{2} ) V = 0$$

$${ω}_{0}^{2} C = - \frac{{RF}_{pr}}{I}$$

When U, V, and C are obtained from the above equations,

U and V are the same as expressed by the following equations when è>0 and when \dot{θ}<0.

$$U = \frac{{ak}_{1} ( {ω}_{0}^{2} - {ω}^{2} )}{I \{ {( {ω}_{0}^{2} - {ω}^{2} )}^{2} + {( 2 ζ {ω}_{0} ω )}^{2} \}} \qquad ( 6 )$$

$$- V = \frac{2 {ak}_{1} ζ {ω}_{0} ω}{I \{ ( {ω}_{0}^{2} - {ω}^{2} ) + {( 2 ζ {ω}_{0} ω )}^{2} \}} \qquad ( 7 )$$

C varies as expressed by the following equations when \dot{θ}>0 and when \dot{θ}<0.
When \dot{θ}>0

$$C = - \frac{{RF}_{pr}}{I {ω}_{0}^{2}} = - \frac{{RF}_{pr}}{{k}_{1} + {k}_{2}} \qquad ( 8 )$$

When \dot{θ}<0

$$C = \frac{{RF}_{pr}}{I {ω}_{0}^{2}} = \frac{{RF}_{pr}}{{k}_{1} + {k}_{2}} \qquad ( 9 )$$

The steady-state solution Op was obtained from equations (6) to (9).

$${θ}_{p} = U sin ω t + V cos ω t + C = A sin ( ω t - δ ) + C$$

When the resistance torque (flexure pitching resistance Fpr) is zero, each of the amplitude A and phase δ is expressed by the following equation.

$$Amplitude A = \sqrt{{U}^{2} + {V}^{2}}$$

$$Phase δ = {tan}^{- 1} ( \frac{- V}{U} )$$

When Fpr is 0 (N) and the sign of the constant term C does not change, the pitch angle of the disk and the pitch angle of the slider match. However, when the resistance torque Fpr exists and the sign of the constant term C changes, the pitch angle of the disk and the pitch angle of the slider do not match.

FIG. 8 shows a relationship between the disk rotation angle and the calculated pitch angle of the slider in a case where Fpr is 0.01 N. In FIG. 8, when the disk rotation angle is between 0° and 90°, the constant term C is negative. Accordingly, the pitch angle of the slider is smaller than the pitch angle of the disk.

In FIG. 8, when the disk rotation angle exceeds 90°, the constant term C changes to a positive value. As a result, the pitch angle of the slider increases discontinuously at 90° and becomes larger than the pitch angle of the disk. When the disk rotation angle exceeds 270°, the constant term C changes to a negative value. Therefore, the pitch angle of the slider decreases discontinuously at 270°, in the calculation. When the disk rotation angle is from 270° to 450°, the pitch angle of the slider changes with a delay relative to the change in the pitch angle of the disk.

When ζ=0 and phase δ=0, solution is expressed by the following equation.

$${θ}_{p} = A sin ( ω t ) + C$$

0<disk angle<90 deg, 270<disk angle<360 deg

$${θ}_{p} = A sin ( ω t ) - \frac{{rF}_{pr}}{{k}_{1} + {k}_{2}}$$

90<disk angle<270 deg

$${θ}_{p} = A sin ( ω t ) + \frac{{rF}_{pr}}{{k}_{1} + {k}_{2}}$$

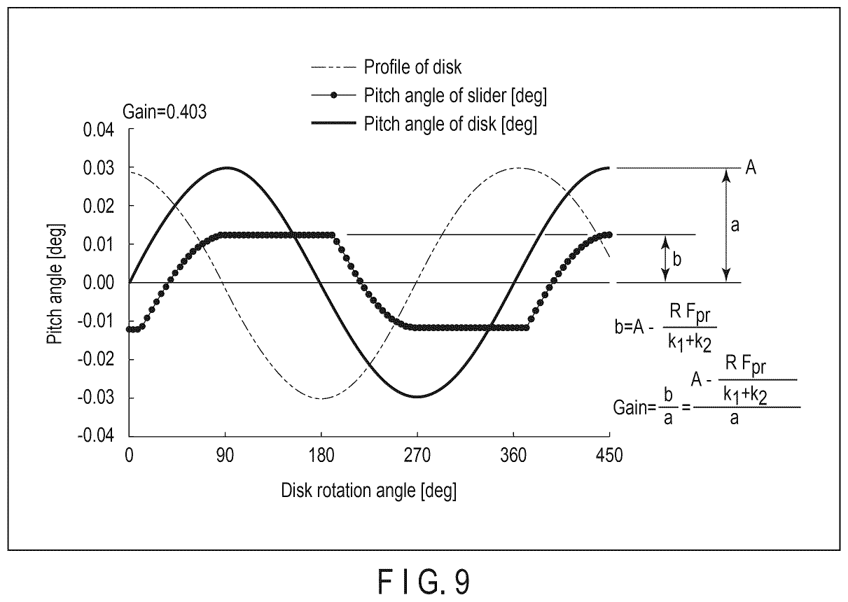

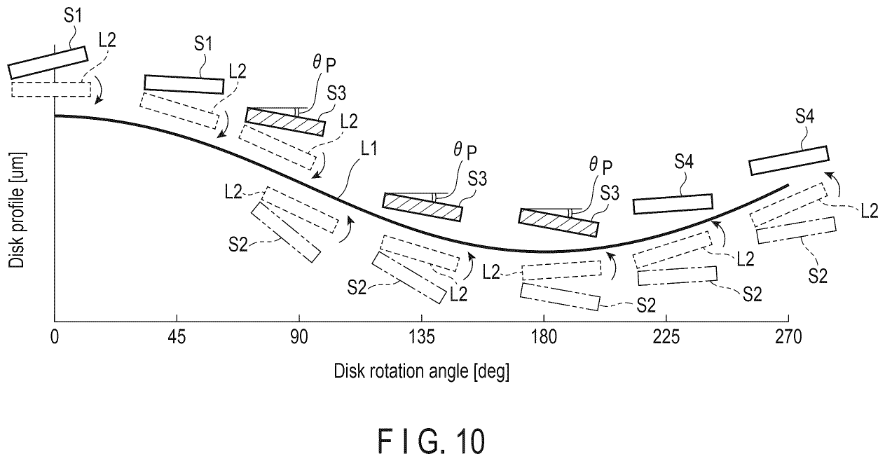

Therefore, the pitch angle of the slider increases or decreases by a constant angle C, within the above range of θ. The pitch angle of the slider changes as shown in FIG. 9. This phenomenon will be described below with reference to FIG. 9 and FIG. 10. Incidentally, the pitch angle of the slider and the pitch angle of the slider-mounted portion are equivalent to each other. As described herein, the pitch angle of the slider-mounted portion may be referred to as the pitch angle of the slider.

FIG. 10 schematically shows a relationship between the profile along the rotational direction of the surface of the disk 12 and the pitch angle of the slider. A solid line L1 in FIG. 10 indicates the profile of the disk. A dashed line L2 in FIG. 10 indicates the slider moving along the surface of the disk 12 when C=0.

As shown in FIG. 9 and FIG. 10, when the disk rotation angle is between 0° and 90°, the pitch angle of the disk is positive. The pitch angle of the disk thereby changes in the direction of increasing. As a result, when the slider rotates in the positive pitch direction, Fpr becomes negative. Therefore, as indicated by the solid line S1 in FIG. 10, the pitch angle of the slider changes in the positive pitch direction with a delay relative to the change in the pitch angle of the disk due to the resistance of Fpr.

When the disk rotation angle exceeds 90°, the pitch angle of the disk changes in the direction of decreasing the pitch angle of the disk (negative pitch direction), causing Fpr to change from a negative value to a positive value. Therefore, when the disk rotation angle exceeds 90°, a force in the positive pitch direction is applied to the slider due to the positive Fpr, as indicated by the dashed line S2 in FIG. 10.

However, when the disk rotation angle exceeds 90°, the pitch angle of the disk changes in the negative pitch direction. Therefore, even if the positive Fpr acts, the rotation of the slider in the positive pitch direction is suppressed. Therefore, until the disk rotation angle exceeds 90° and passes 180°, the pitch angle θp of the slider does not change but remains constant, as indicated by hatching S3 in FIG. 10.

When the disk rotation angle exceeds 180°, the pitch angle of the disk becomes negative, and the absolute value of the pitch angle increases. At this time, since Fpr has a positive value, the resistance caused by Fpr acts in a direction of reducing the pitch angle of the slider. Therefore, until the disk rotation angle approaches 270°, the pitch angle of the slider changes with a delay relative to the pitch angle of the disk, as indicated by $4 in FIG. 10.

When the disk rotation angle exceeds 270°, the pitch angle of the disk changes in the positive direction, causing Fpr to change from a positive value to a negative value. Therefore, when the disk rotation angle exceeds 270°, a force in the negative pitch direction is applied to the slider due to the negative Fpr.

However, when the disk rotation angle exceeds 270°, the pitch angle of the disk changes in the positive pitch direction. Therefore, even if the negative Fpr acts, the rotation of the slider in the negative pitch direction is suppressed. Therefore, until the disk rotation angle exceeds 270° and passes 360°, the pitch angle of the slider does not change but remains constant. When the disk rotation angle exceeds 360°, the same phenomenon as that occurring when the disk rotation angle is from 0° to 360° is repeated.

As shown in FIG. 9, when the input amplitude is denoted as a, the gain is expressed by the following equation. A is the amplitude, R is the radius of curvature of the convex surface 51, and Fpr is the flexure pitching resistance. k1 is a pitching stiffness of air bearing, and k₂ is a pitching stiffness of the slider-mounted portion 30.

$$Gain = \frac{A - \frac{{RF}_{pr}}{{k}_{1} + {k}_{2}}}{a}$$

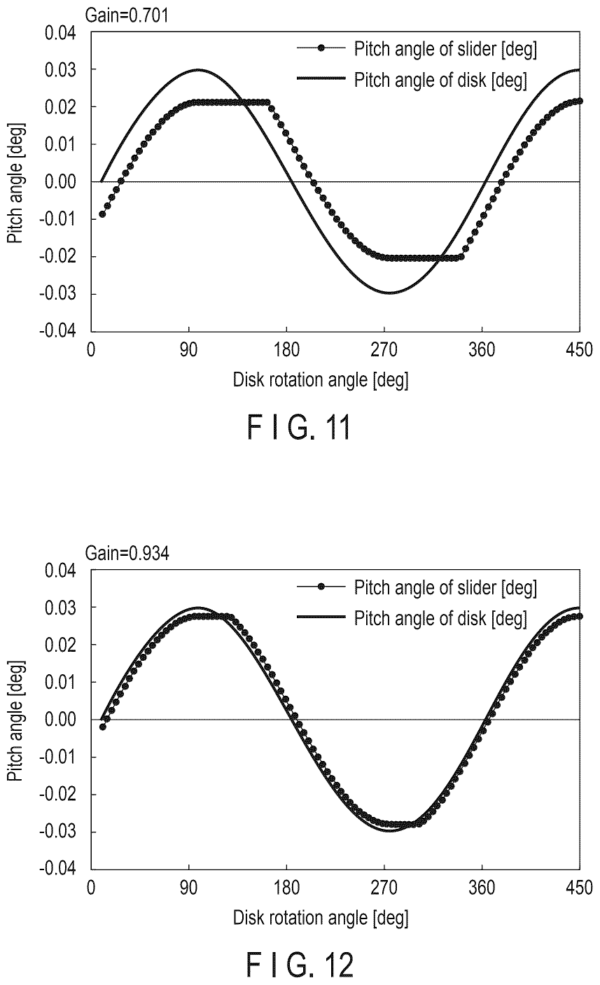

FIG. 11 shows a relationship between the pitch angle of the disk and the pitch angle of the slider in an example in which the gain is 0.701. In the example shown in FIG. 11, since the difference between the pitch angle of the disk and the pitch angle of the slider is large, the slider may interfere with the disk.

FIG. 12 shows a relationship between the pitch angle of the disk and the pitch angle of the slider in an example in which the gain is 0.934. In the example shown in FIG. 12, since the difference between the pitch angle of the disk and the pitch angle of the slider is small, interference between the slider and the disk is unlikely to occur.

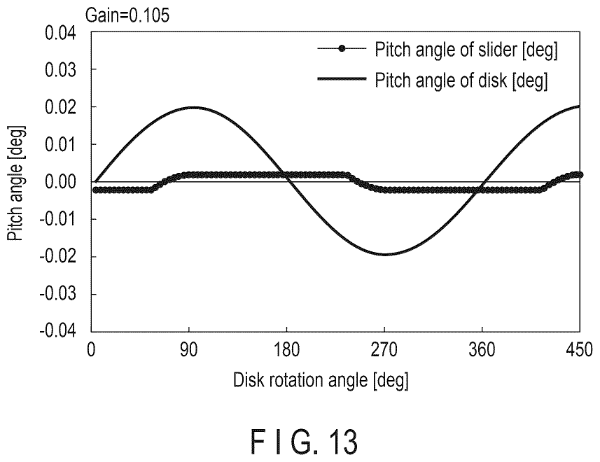

FIG. 13 shows a relationship between the pitch angle of the disk and the pitch angle of the slider in an example in which the gain is 0.105. In the example shown in FIG. 13, since the difference between the pitch angle of the disk and the pitch angle of the slider is quite large, there is a high possibility of interference between the slider and the disk.

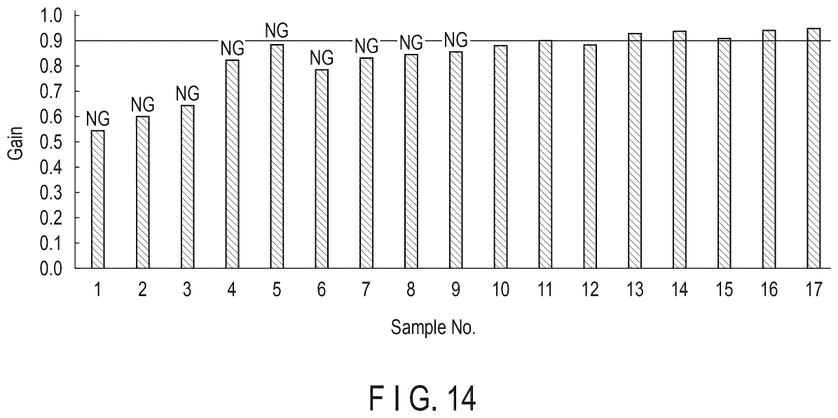

FIG. 14 shows the gains for respective samples Nos. 1 to 17 of the suspension. Samples No. 1 to No. 9 were determined to have problem (NG) since the gains were small and the slider might interfere with the disk. In Samples No. 10 to No. 17, interference of the slider with the disk was avoided. To avoid interference between the disk and the slider, the gain is 0.9 or more and more desirably 9.5 or more.

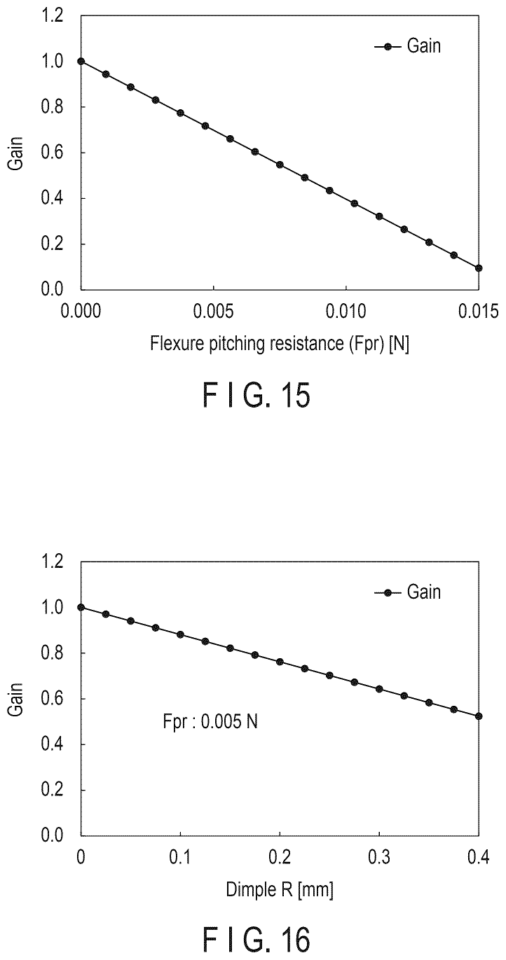

FIG. 15 shows a relationship between the flexure pitching resistance Fpr and the gain. The flexure pitching resistance Fpr influences the gain. The gain becomes larger as Fpr is smaller. In particular, when Fpr was less than 0.005 N, the gain could be made closer to a desired value. FIG. 16 shows the results of analyzing the relationship between the radius of curvature R of the dimple and the gain in a case where Fpr is 0.005 N. When the radius of curvature R of the dimple is smaller than 0.1, the gain can be made closer to 0.9. In particular, when the radius of curvature R is smaller than 0.085, the gain can be set to 0.9 or more.

As a result of intensive research, the present inventors found that to suppress the interference between the slider and the disk, it is effective to set the gain to 0.9 or more, preferably 0.95 or more. To set the gain to 0.9 or more, it is desirable to set the flexure pitching resistance Fpr to 0.005 N or less, and to set the radius of curvature R of the convex surface to less than 0.10 mm, more desirably, less than 0.085 mm.

Due to the limitations of the mold used to form the dimple portion 50, it is practically difficult to make the radius of curvature R smaller than 0.04 mm. Therefore, the radius of curvature R is set to 0.04 mm or more. The height h3 of the dimple portion (shown in FIG. 4) is, for example, 0.04 mm to 0.07 mm, but may be a height other than this.

In implementing the present invention, it goes without saying that various modifications may be made to the components constituting the suspension, including specific aspects such as shapes and positions of the load beam, the flexure, the slider, and the dimple portion. The disk drive can also take various forms as necessary without being limited to the above-described embodiments.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A disk drive suspension comprising:
a load beam;
a flexure provided along the load beam and including a slider-mounted portion on which a slider is mounted, the slider-mounted portion having a first surface facing the load beam and a second surface on which the slider is provided;
a dimple portion formed on the load beam and having a convex surface which is in contact with the first surface of the slider-mounted portion; and
a gimbal component swingably supporting the slider-mounted portion in at least a pitching direction, wherein
a radius of curvature of the convex surface which is in contact with the slider-mounted portion is less than 0.10 mm, and 0.04 mm or more, and
a gain defined by following equation is 0.9 or more.
$$Gain = \frac{A - \frac{{RF}_{pr}}{{k}_{{1}^{+}} {k}_{2}}}{a}$$
a: Input amplitude
A: Amplitude
R: Radius of curvature of convex surface of dimple
Fpr: Flexure pitching resistance
k1: Pitch stiffness of air bearing
k₂: Pitch stiffness of flexure (gimbal portion)

2. The suspension of claim 1, wherein
the gain is 0.95 or more.

3. The suspension of claim 1, wherein
the radius of curvature of the convex surface is less than 0.85 mm.

4. The suspension of claim 1, wherein
a flexure pitching resistance which acts on a contact part in contact with the convex surface when the slider-mounted portion moves in the pitching direction is 0.005 N or less.
